(19) United States
(12) Patent Application Publication
(10) Pub. No.: US 2020/0250777 A1
(43) Pub. Date: Aug. 6, 2020

(54) FREE TEXT MODEL EXPLANATION HEAT MAP

(71) Applicant: Clara Analytics, Inc., Santa Clara, CA (US)

(72) Inventors: Hari Sarang Nathan, Santa Clara, CA (US); Zhe Jia, San Jose, CA (US)

(21) Appl. No.: 16/777,628

(22) Filed: Jan. 30, 2020

Related U.S. Application Data
(60) Provisional application No. 62/802,169, filed on Feb. 6, 2019.

(51) Int. Cl. G06Q 50/18; G06N 5/02; G06N 20/00

(52) U.S. Cl. CPC G06Q 50/18; G06N 20/00; G06N 5/02

(57) ABSTRACT

A system and a method are disclosed herein for identifying relevant portions of document. In an embodiment, a processor of a server receives a request from a user to determine a prediction. The processor identifies documents corresponding to the request, and identifies portions of the documents that inform the prediction. The processor inputs at least the portions of the documents into a machine learning model, and receives, as output from the machine learning model, the prediction. The processor outputs the prediction for display to the user. The processor receives a request from the user to view a document that informed the prediction, and generates for display with the document a heat map that indicates how parts of the document that are included in the portions of the documents that informed the prediction influenced the prediction.

### CROSS REFERENCE TO RELATED APPLICATIONS

This application claims the benefit of U.S. Provisional Application No. 62/802,169, filed Feb. 6, 2019, which is incorporated by reference in its entirety.

### TECHNICAL FIELD

The disclosure generally relates to the field of predictive modeling based on text mining, of, e.g., documents, and more specifically relates to an improved user interface for displaying results of the predictive modeling (e.g., by identifying portions of a document that most heavily influenced a given information request).

### BACKGROUND

Related art systems rely on machine learning algorithms to hone determinations of relevance to users. However, after determining relevance of candidate objects (e.g., documents), the output of these algorithms is a ranked list of results, without indicia of why the ranking was generated in the output manner. For example, in the context of a document search, based on machine learning models as applied to the input of a search, some documents are presented to a user over other candidate documents as a result of a search. While some related art systems show that a particular searched term exists in a search result (e.g., a keyword of a search string may be highlighted when a search result is selected), these related art systems fail to highlight with any level of granularity portions of free text that lead to a prediction (e.g., of relevance, sentiment, and the like), beyond mere keyword matching. This problem is especially pronounced in long documents, where, for example, ten non-consecutive pages out of one thousand may have factored into a determination to output the long document as a search result; simply noting a particular keyword of a search that was prevalent in the long document does not inform the user of why the machine model itself selected the document, or ranked the document a certain way.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG. 1 illustrates one embodiment of a system diagram for implementing a free text explanation service, in accordance with some embodiments of the disclosure.

FIG. 2 illustrates one embodiment of a block diagram illustrating components of an example machine able to read instructions from a machine-readable medium and execute them in a processor (or controller), in accordance with some embodiments of the disclosure.

FIG. 3 illustrates one embodiment of modules and data accessed by a free text explanation service, in accordance with some embodiments of the disclosure.

FIG. 4 illustrates one embodiment of a user interface including a free text explanation with a single-instance heat map, in accordance with some embodiments of the disclosure.

FIG. 5 illustrates one embodiment of a user interface including a free text explanation with a two-instance heat map, in accordance with some embodiments of the disclosure.

FIG. 6 illustrates one embodiment of a user interface including a free text explanation with a multi-instance heat map, where each instance corresponds to a selectable option, in accordance with some embodiments of the disclosure.

FIG. 7 illustrates one embodiment of a user interface including a zoom ability for a heat map, in accordance with some embodiments of the disclosure.

FIG. 8 illustrates one embodiment of an exemplary flowchart for identifying relevant portions of documents and generating a heat map therefrom, in accordance with some embodiments of the disclosure.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system, method and computer readable storage medium that includes an output of a user interface with a heat map that explains why a search module's machine learning model made a certain prediction. For example, an insurance company that employs defense attorneys to defend workers compensation claims may wish to determine whether a given defense attorney is performing adequately. A worker of the insurance company may run a search through textual documents that are used to predict, based on a machine learning model, whether the given defense attorney is performing adequately. The worker may be presented with a user interface that shows a document resulting from the search concurrently with a heat map that shows which areas of the document(s) informed a prediction that the given defense attorney is, or is not, performing adequately as well as (potentially) the degree to which each portion of these documents(s) contributed to said prediction. For example, the heat map may be a scroll bar that corresponds to the document, and that is encoded based on a sentiment analysis of the document.

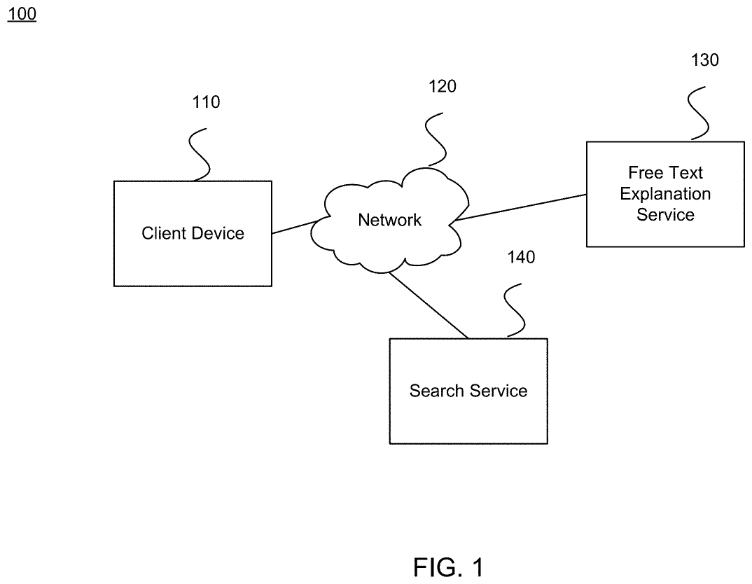

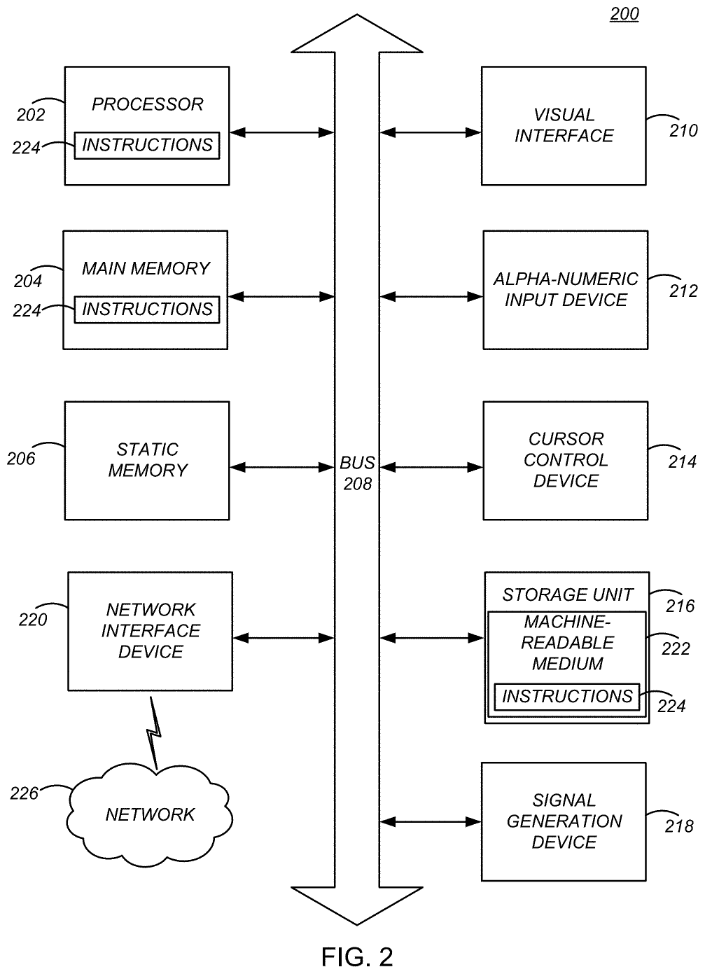

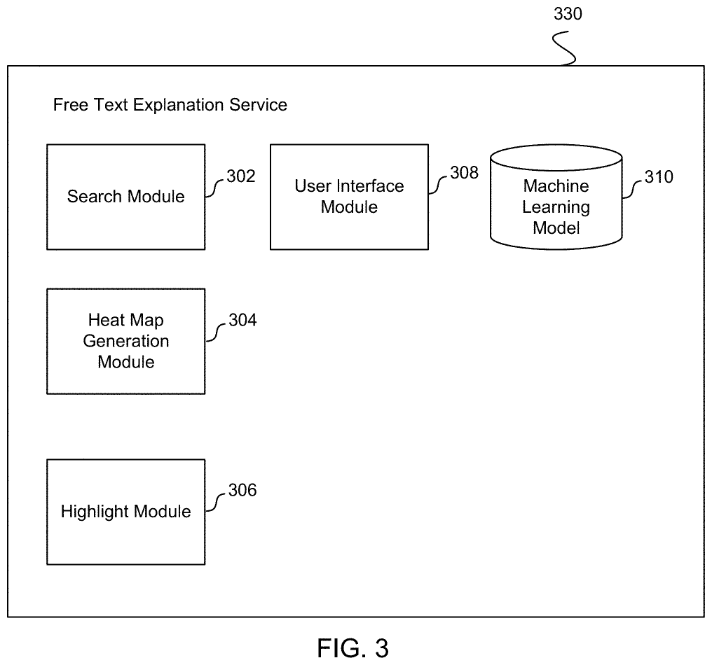

FIG. 1 illustrates one embodiment of a system diagram for implementing a free text explanation service, in accordance with some embodiments of the disclosure. System 100 includes client device 110, network 120, free text explanation service 130, and search service 140. Client device 110 may be any computing device that is operably coupled to a display, such as computer system 200, which will be described with further detail with reference to FIG. 2 below. Client device 110 may be an end-user device, such as a device used by an insurance defense company or a company affiliated therewith. Client device 110 communicates through network 120 with free text explanation service 130 and/or search service 140. Communications may include, for example, search requests for topics, such as legal cases, and/or documents associated with those topics, as well as requests for analysis (e.g., sentiment analysis, highlighting, etc.) of resultant topics and/or documents. As is described in further detail below with reference to FIGS. 3-8, free text explanation service 130 outputs one or more explanations, such as word highlighting, a heat map, etc. to explain search results returned by search service 140. While free text explanation service 130 and search service 140 are depicted as separate entities, these entities may be co-located, either at a single location, or at some or all of servers distributed at different points of network 120. Free text explanation service and/or search service 140 may each be instantiated on one or more servers, and their functionality may be partially or fully instantiated in one or more applications installed within client device 110.

### Computing Machine Architecture

FIG. 2 is a block diagram illustrating components of an example machine able to read instructions from a machine-readable medium and execute them in a processor (or controller). Specifically, FIG. 2 shows a diagrammatic representation of a machine in the example form of a computer system 200 within which program code (e.g., software) for causing the machine to perform any one or more of the methodologies discussed herein may be executed. The program code may be comprised of instructions 224 executable by one or more processors 202. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 224 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 200 includes a processor 202 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 204, and a static memory 206, which are configured to communicate with each other via a bus 208. The computer system 200 may further include visual display interface 210. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 210 may include or may interface with a touch enabled screen. The computer system 200 may also include alphanumeric input device 212 (e.g., a keyboard or touch screen keyboard), a cursor control device 214 (e.g., a mouse, a trackball, a joystick, a motion sensor, or other pointing instrument), a storage unit 216, a signal generation device 218 (e.g., a speaker), and a network interface device 220, which also are configured to communicate via the bus 208.

The storage unit 216 includes a machine-readable medium 222 on which is stored instructions 224 (e.g., software) embodying any one or more of the methodologies or functions described herein. The instructions 224 (e.g., software) may also reside, completely or at least partially, within the main memory 204 or within the processor 202 (e.g., within a processor's cache memory) during execution thereof by the computer system 200, the main memory 204 and the processor 202 also constituting machine-readable media. The instructions 224 (e.g., software) may be transmitted or received over a network 226 via the network interface device 220.

While machine-readable medium 222 is shown in an example embodiment to be a single medium, the term “machine-readable medium” should be taken to include a single medium or multiple media (e.g., a centralized or distributed database, or associated caches and servers) able to store instructions (e.g., instructions 224). The term “machine-readable medium” shall also be taken to include any medium that is capable of storing instructions (e.g., instructions 224) for execution by the machine and that cause the machine to perform any one or more of the methodologies disclosed herein. The term “machine-readable medium” includes, but not be limited to, data repositories in the form of solid-state memories, optical media, and magnetic media.

### Free Text Explanation Service—Exemplary Components

FIG. 3 illustrates one embodiment of modules and data accessed by a free text explanation service, in accordance with some embodiments of the disclosure. Free text explanation service 330 includes all features discussed above with respect to free text explanation service 130. Free text explanation service 330 includes search module 302. In an embodiment where free text explanation service 130 provides the functionality of search service 140, processor 202 of free text explanation service 330 executes search module 302 when a search is to be performed. A search is to be performed, either for topics (e.g., insurance defense cases), and/or documents (e.g., relating to a particular case), responsive to receiving a request from client device 110 relating to performance of a search.

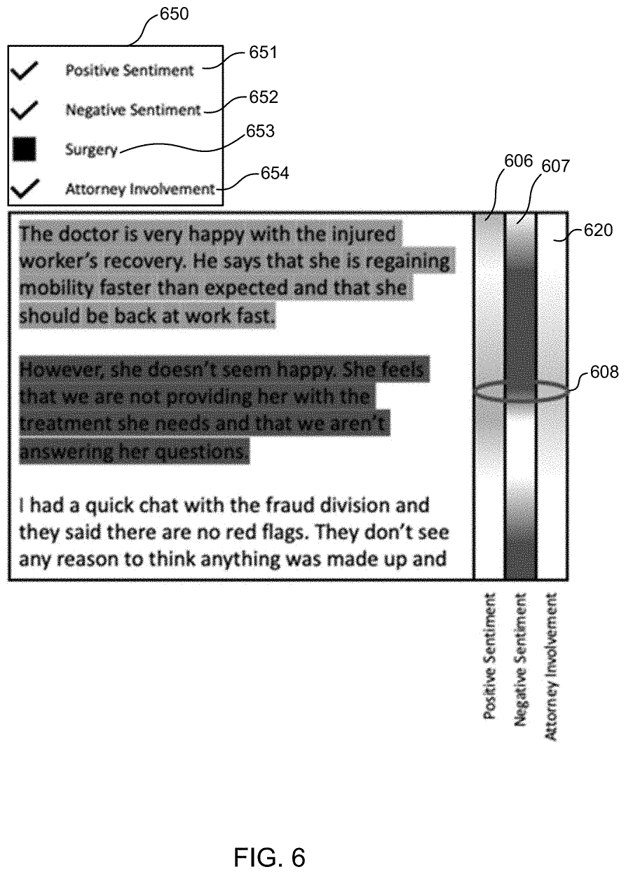

Search module 302, when executed, may call on user interface module 308 to generate for display a user interface to a user (e.g., by way of visual interface 210 of client device 110). The user interface may accept search terms, such as any of, or a combination of, a selection of a defense attorney, a selection of a document, a selection of a filter (to be described in further detail with respect to FIG. 6 below), an input of one or more keywords, and the like, and may feed the search terms to search module 302. As another example, following the defense attorney example mentioned above, the user interface may list names of cases, or law suits, and a user interface may accept a selection of one of the cases. In another embodiment, rather than search module 302 call on user interface module 308, user interface module 308 may be initiated by a third-party service (e.g., search service 140), which feeds the search terms to search module 302. Examples provided herein with respect to insurance and insurance defense are exemplary and used for convenience; this disclosure equally applies to any topics to which documents correspond.

Processor 202 may generate for display search results found by way of search module 302, and may cause the search results to be displayed to a user of client device 110 by executing user interface module 308. Search results may include identifiers of topics and/or documents corresponding to a selected topic. Again following the defense attorney example mentioned above, in response to detecting selection of a given case, user interface module 308 may generate for display an indication that there is a 67% chance that a workers compensation applicant is going to win a particular case, and a 33% chance that the respondent (e.g., insurance company) will win the case, as part of the search results. This determination of probabilities may be made by, e.g., heat map generation module 304, or any other predictive module. In addition to search results, user interface module 308 may generate for display at client device 110 a heat map that explains what parts of a given document led to a prediction (e.g., of defense attorney performance). The given document may be selected by a user of client device 110. For example, selection of a topic from search results indicating odds of success may result in a listing of documents that were used to inform the determination of the odds of success. Again following from the defense attorney example mentioned above, user interface module 308 may detect selection of a selectable option that requests more information as to why the depicted probabilities are accurate representation of outcome chance. Heat map module 304 may be used, as described below, to highlight certain portions of one or more documents to accentuate portions of the documents that led to the prediction of probabilities.

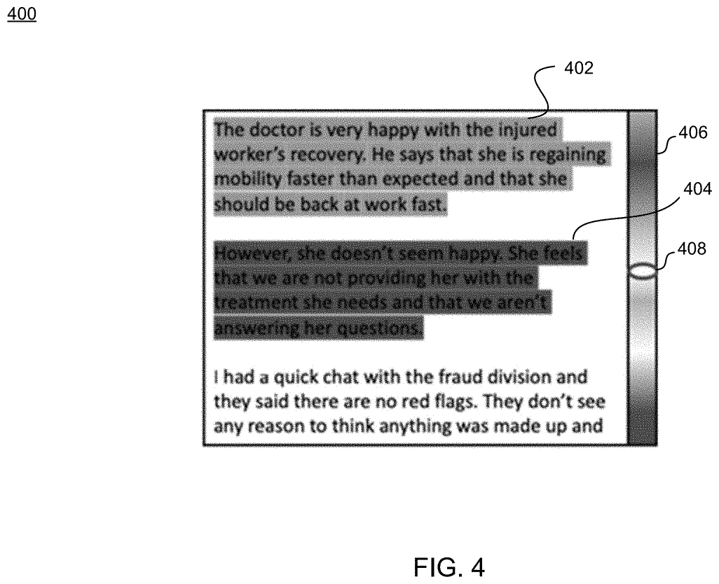

In order to populate the heat map, processor 202 executes heat map generation module 304. Processor 202 may execute heat map generation module 304 based on a user request, or processor 202 may execute heat map generation module 304 automatically, either when a search result is populated, or when a user of client device 110 selects a document. Heat map generation module 304 generates a heat map (e.g., a scroll bar including different emphases or colorations) based on how influential a given portion of a document that corresponds to a point on, e.g., the scroll bar, was in causing the document to be part of the search result, or in causing a prediction to be made (e.g., a defense attorney score). The heat map, and how the heat map is generated, will be described in further detail with respect to FIGS. 4-8 below.

In some embodiments, as an alternative, or as an addition, to heat map generation module 304, processor 202 may execute highlight module 306. Highlight module 306 may highlight terms of a document that influenced the prediction made by search module 302 based on machine learning model 310. The highlight may be performed in different colors, or different levels of grayscale, based on a type of influence (e.g., positive or negative sentiment), based on a degree of influence (e.g., highly positive, or marginally positive), and based on any other factor. The term highlight may also refer to any other form of emphasis, such as bolding, italicizing, or any other manipulation of text that differentiates the text being highlighted from other text in the document. Further details about highlight module 306 will be described below with respect to FIGS. 4-7 below. Highlight module 306 may be a sub-module of heat map generation module 304, and may be called on by heat map generation module 304 as an additional manner of conveying explanation of how inferences are formed.

### Heat Map Generation

FIG. 4 illustrates one embodiment of a user interface including a free text explanation with a single-instance heat map, in accordance with some embodiments of the disclosure. FIG. 4 depicts user interface 400, which may be generated for display by processor 202 of client device 110 and/or by processor 202 of free text explanation service 330. As an illustrative example, contents of the document depicted in user interface 400 forms part of a prediction made of defense attorney performance, and processor 202 generated for display user interface 400 to show why a machine learning model (e.g., machine learning model 310) made a prediction that the defense attorney performance is, or is not, adequate. In the workers compensation field, a defense attorney for an insurance company is likely to perform better if an applicant for workers compensation is satisfied with how the applicant is compensated for his or her injury, how the applicant is treated by doctors, how quickly the applicant is recovering, and the like.

The machine learning model may be trained using training data including portions of documents that are annotated with a corresponding category, and optionally, a degree to which the portions correspond to the category. For example, for a defense attorney performance machine learning model, the training data may indicate whether, and to what degree, certain words, strings of words, and the like indicate that the defense attorney is likely to succeed.

Following training, the machine learning model may take one or more documents as input. Search module 302 and/or heat map generation module 304 may select documents for input by searching for documents based on parameters of the search request. In the context of the defense attorney example, the documents may be selected based on their being drafted by the defense attorney, based on their being involved in a case that the defense attorney worked on, based on their informing an issue relating to a case for which likelihood of success by a particular defense attorney is being determined, and so on. Optionally, the machine learning model may be trained to additionally take as input one or more parameters (e.g., attorney involvement, related to surgery, etc).

The machine learning module may output, in addition to its determination of defense attorney performance, a weight applied to relevant portions of documents in informing the determination of defense attorney performance. Heat map generation module 304 and/or highlight module 306 may use the weights to determine what to highlight and how to generate the heat map for a given document. Optionally, where parameters were taken as input, the machine learning model may output one or more parameter-specific weights that indicate a degree to which a part of a document that informed determination of defense attorney performance corresponds to the particular parameter. For example, where the parameter “surgery” was taken as input, the machine learning model may indicate which relevant portions of the documents in informing determination of defense attorney performance also correspond to surgery. Optionally, multiple machine learning models may be used, one dedicated to identifying portions of documents that inform a prediction, and additional one(s) dedicated to identifying a degree of influence of each identified portion, identifying which portions correspond to given parameters, and so on. While the disclosure is primarily described with respect to a machine learning model, the term encompasses any type of model, including classifiers, predictive models, and so on.

In an embodiment, processor 202 may execute heat map generation module 304 and/or highlight module 306, which may, as described above, input a document into machine learning model 310, which outputs weights that inform a determination of aspects of the document that form an inference of applicant satisfaction, and applicant dissatisfaction (which in turn form an inference of defense attorney performance). For example, heat map generation module 304 may highlight section 402 with a light color, such as green, because section 402 correlates to positive performance, given that it indicates applicant satisfaction because the applicant is recovering more quickly than expected. Heat map generation module 304 highlights section 404 a dark color, such as red, because section 404 correlates to negative performance, given that it indicates applicant dissatisfaction because the applicant is not happy. While sections 402 and 404 are highlighted in light and dark colors, heat map generation module and/or highlight module 306 may use any color or other form of shading, bordering, or other accentuation to indicate positive or negative performance.

Heat map generation module 304 may determine that different sections of the document correspond to different degrees of defense attorney performance (e.g., based on the weights output by the machine learning model); depth of coloration or shading or bordering may be output by heat map generation module 304 to indicate sections that form a strong or weak prediction. For example, if a section forms a particularly strong inference that an applicant attorney is performing poorly, then the section may be highlighted in deep red, or may be bordered by a solid black line. If a section forms a particularly weak inference that an applicant attorney is performing poorly, then the section may be highlighted in faint red, or may be bordered by a thin, dashed line. The manner in which degrees of inference are highlighted may be commanded by a user of client device 110 (e.g., by way of a selection of settings on user interface 400), or may be default settings programmed for user by user interface module 308.

In addition to, or alternative to, the use of highlighting, heat map generation module 304 may generate heat map 406. Heat map 406 is depicted as a scroll bar, where each point along the scroll bar corresponds to progress through a given document. For example, twenty-five percent of the way down the scroll bar may correspond to a page of the document that is twenty-five percent of the way through the document. The scroll bar is merely exemplary; the heat map may be depicted in any form, such as a direct background of the document or in any other form. Heat map generation module 304 generates heat map 406 based on a degree to which sections that, in the aggregate, form a portion of heat map 406 form a positive or negative correlation. For example, section 408 of heat map 406 is white. This is because heat map generation module 304 determines that the section, which is depicted in user interface 400, includes section 402, which forms an inference of positive performance, and also includes section 404, which forms an inference of negative performance. Heat map generation module 304 determines that sections 402 and 404 cancel each other out, and thus section 408 of heat map 406 does not, as a whole, add to an inference of either positive or negative applicant attorney performance.

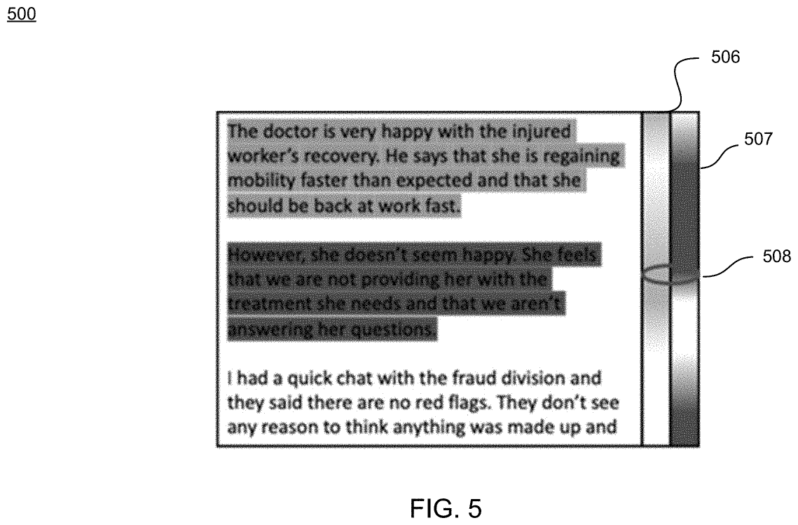

FIG. 5 illustrates one embodiment of a user interface including a free text explanation with a two-instance heat map, in accordance with some embodiments of the disclosure. User interface 500 includes the same segment of the document depicted in user interface 400. In a scenario where heat map generation module 304 is performing an analysis where the field of inferences to be made is one of two possible outcomes (e.g., positive or negative), heat map generation module 304 may generate two heat maps, such as heat map 506 and heat map 507. As depicted, heat map 506 includes a heat map depicting portions of the document that include text that form an inference of positive defense attorney performance. Heat map 507 includes a heat map depicting portions of the document that include text that form an inference of negative attorney performance. Like heat map 406, heat maps 506 and 507 have varying degrees of depth of color (e.g., light red to dark red) to depict the degree to which an inference of positive or negative performance is made. Where the depth of color is the same (e.g., at section 508), an inference made from that section is neutral, because the positive and negative cancel each other out.

In some embodiments, user interface module 308 may generate more than two heat maps (e.g., scroll bars), where some, e.g., scroll bars conform to a heat map based on inferences of attorney performance, and other scroll bars may conform to areas of the document where text corresponding to a selectable option occurs. FIG. 6 illustrates one embodiment of a user interface including a free text explanation with a multi-instance heat map, where each instance corresponds to a selectable option, in accordance with some embodiments of the disclosure. User interface 600 includes, again, the same section of the document shown in user interfaces 400 and 500. User interface 650 is also depicted, and includes selectable options 651-654.

Selectable option 651 corresponds to a heat map for positive sentiment, selectable option 652 corresponds to a heat map for negative sentiment, selectable option 653 corresponds to a heat map for surgery, and selectable option 654 corresponds to a heat map for attorney involvement. Selectable option 653 is not checked off (i.e., not selected by a user), and thus no heat map for surgery is displayed as part of user interface 600. Selectable options 651, 652, and 654, however, are checked off, and thus heat maps 606, 607, and 620 are displayed as part of user interface 600, showing information corresponding to the selected options, respectively.

Notably, as depicted in FIG. 6, heat maps for surgery and attorney Involvement do not require a binary inference to be made by heat map generation module 304. Rather, machine learning model 310 annotates the document (e.g., with highlights) for sections of the document that correspond to, e.g., surgery (e.g., because words that relate to surgery are stated). Thus, because section 608 discusses an attorney failing to answer the applicant's questions, section 608 of heat map 620 (which corresponds to attorney involvement) is shaded to show that attorney involvement is discussed at section 608. Selectable options for any annotation or parameter understandable by machine learning model 310 may be generated for display in user interface 650, and additional heat maps for each selectable option may be generated for display.

The selectable options of user interface 650, rather than causing an additional heat map to display when selected, may act as filters. For example, if selectable option 654 is selected, then sentiment analysis as to whether a defense attorney is performing satisfactorily may be performed only where that information relates to parts of a document where an attorney is involved. For example, if a document indicates that a surgeon made a mistake when performing surgery in connection with a workers compensation injury, if selectable option 654 is selected, then because the surgeon's mistake has nothing to do with attorney involvement, heat map generation module will not include negative highlighting or negative showing in heat map 607 based on the portion of the document discussing the mistake.

In some embodiments, color intensity on a given heatmap (e.g., heatmap 607) may become more or less intense to show dimensions other than intensity of a sentiment. For example, if machine learning model correlates some text to an emotion of “annoyed,” and other text to an emotion of “angry,” then “annoyed” may be shaded a light red, and “angry” may be shaded a deep red. Any such dimension or level of intensity may be used to drive the depth of shading of the heat map. Furthermore, colors depend on the eye of the beholder; if the same user interface 400 was to be used to analyze performance of the applicant's attorney, rather than the defense attorney, then the colors may be inverted, as good defense attorney performance may correlate inversely to good applicant attorney performance.

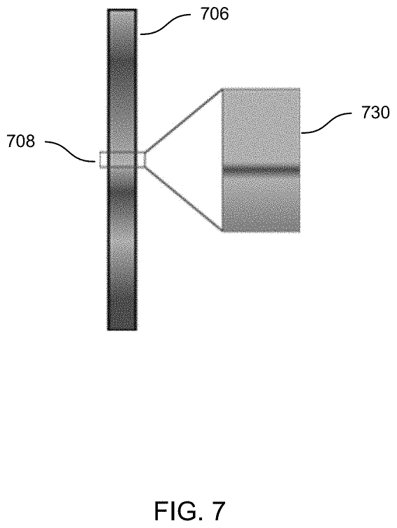

FIG. 7 illustrates one embodiment of a user interface including a zoom ability for a heat map, in accordance with some embodiments of the disclosure. In some embodiments, a document may be very long, and thus a pixel on a scroll bar may correspond to multiple pages of text. In such cases, such as with heat map 706, processor 202 may detect that a user selects or otherwise triggers a zoom function with respect to a portion of heat map 706. Processor 202 may responsively generate for display a zoomed-in perspective of the selected section (e.g., section 730, which is a zoomed-in perspective of section 708) to enable a more granular view. For illustrative convenience, the above-described embodiments were illustrated with reference to a search performed in connection with evaluating defense attorney performance in the context of workers compensation claims. However, one of ordinary skill in the art would recognize that the above-described embodiments apply equally to any embodiment where a machine learning model is called upon by, or in connection with, execution of a search module, where explanation of the reasoning behind the output of the search module is desired by a user.

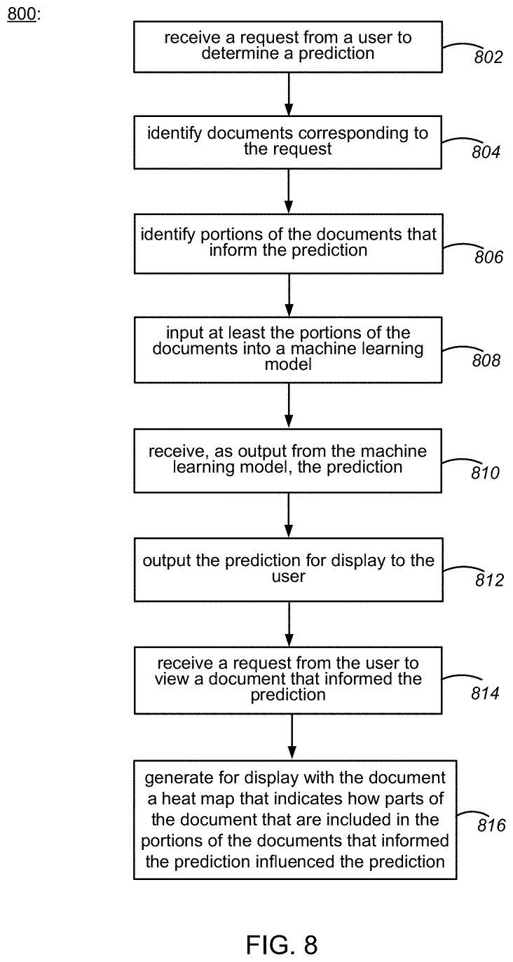

FIG. 8 illustrates one embodiment of an exemplary flowchart for identifying relevant portions of documents and generating a heat map therefrom, in accordance with some embodiments of the disclosure. Process 800 begins at 802, where a processor of a server (e.g., free text explanation service 130) receives 702 a request from a user to determine a prediction (e.g., a likelihood of success for a particular defense attorney to succeed in a legal matter). The server identifies 704 documents corresponding to the request (e.g., using search service 140 and/or search module 302). The server identifies 706 portions of the documents that inform the prediction (e.g., using heat map generation module 304 and/or machine learning model 310).

The server inputs 708 at least the portions of the documents into a machine learning model (e.g., machine learning model 310). The server receives 710, as output from the machine learning model, the prediction. The server outputs 712 the prediction for display to the user (e.g., using user interface module 308, the output reaching client device 110 by way of network 120). The server receives 714 a request from the user to view a document that informed the prediction (e.g., the document depicted in user interface 400). The server generates for display 716 with the document a heat map (e.g., heat map 406) that indicates how parts of the document that are included in the portions of the documents that informed the prediction influenced the prediction. The document may be additionally highlighted using highlight module 306.

### Additional Configuration Considerations

Advantages of the heat maps and highlighting discussed in this disclosure include an improved user interface that enables users to identify sections of documents that influenced a determination (e.g., a determination of likelihood of success), as well as a degree to which those sections caused influence. Moreover, users are able to easily isolate one or more specific parameters that influenced the determination and cause the heat map to reflect those parameters, to the exclusion of other parameters that may be causing noise in the analysis.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for generating a heat map through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for identifying relevant portions of documents, the method comprising:
receiving, by a server, a request from a user to determine a prediction;
identifying, using the server, documents corresponding to the request;
identifying portions of the documents that inform the prediction;
inputting at least the portions of the documents into a machine learning model;
receiving, as output from the machine learning model, the prediction;
outputting the prediction for display to the user;
receiving a request from the user to view a document that informed the prediction; and
generating for display with the document a heat map that indicates how parts of the document that are included in the portions of the documents that informed the prediction influenced the prediction.

2. The method of claim 1, wherein receiving the request comprises receiving a selection of a topic, and wherein identifying the documents comprises identifying documents that correspond to the topic.

3. The method of claim 2, wherein the topic is a legal case, wherein receiving the request additionally comprises receiving a selection of an individual, and wherein the prediction is a likelihood of success of the individual in achieving a successful outcome in the legal case.

4. The method of claim 1, wherein identifying the portions of the documents that inform the prediction comprises:
inputting the documents into a machine learning model; and
receiving, as output from the machine learning model, an indication of the portions of the documents that inform the prediction.

5. The method of claim 4, wherein the indication of the portions of the documents that inform the prediction comprise respective weights for each respective portion corresponding to an amount by which the respective portion informed the prediction.

6. The method of claim 1, wherein the heat map factors in, for each part of the document of the parts of the document corresponding to a given location in the heat map, an amount by which the given location in the heat map was impacted by both positive and negative influence.

7. The method of claim 1, wherein the heat map is influenced by multiple parameters, and wherein the method further comprises:
receiving, from the user, a de-selection of a parameter of the multiple parameters; and
updating the heat map to remove indications of influence of parts of the document corresponding to the de-selected parameter.

8. The method of claim 1, wherein generating for display the heat map comprises generating for display a plurality of heat maps, each respective one of the plurality of heat maps showing where the parts of the document influenced the prediction based on a respective parameter corresponding to the respective heat map.

9. A non-transitory computer-readable medium comprising memory with instructions encoded thereon for identifying relevant portions of documents, the instructions causing one or more processors to perform one or more operations when executed, the instructions comprising instructions to:
receive, by a server, a request from a user to determine a prediction;
identify, using the server, documents corresponding to the request;
identify portions of the documents that inform the prediction;
input at least the portions of the documents into a machine learning model;
receive, as output from the machine learning model, the prediction;
output the prediction for display to the user;
receive a request from the user to view a document that informed the prediction; and
generate for display with the document a heat map that indicates how parts of the document that are included in the portions of the documents that informed the prediction influenced the prediction.

10. The non-transitory computer-readable medium of claim 9, wherein the instructions to receive the request comprise instructions to receive a selection of a topic, and wherein identifying the documents comprises identifying documents that correspond to the topic.

11. The non-transitory computer-readable medium of claim 10, wherein the topic is a legal case, wherein the instructions to receive the request additionally comprise instructions to receive a selection of an individual, and wherein the prediction is a likelihood of success of the individual in achieving a successful outcome in the legal case.

12. The non-transitory computer-readable medium of claim 9, wherein the instructions to identify the portions of the documents that inform the prediction comprise instructions to:
input the documents into a machine learning model; and
receive, as output from the machine learning model, an indication of the portions of the documents that inform the prediction.

13. The non-transitory computer-readable medium of claim 12, wherein the indication of the portions of the documents that inform the prediction comprise respective weights for each respective portion corresponding to an amount by which the respective portion informed the prediction.

14. The non-transitory computer-readable medium of claim 9, wherein the heat map factors in, for each part of the document of the parts of the document corresponding to a given location in the heat map, an amount by which the given location in the heat map was impacted by both positive and negative influence.

15. The non-transitory computer-readable medium of claim 9, wherein the heat map is influenced by multiple parameters, and wherein the instructions further comprise instructions to:
receive, from the user, a de-selection of a parameter of the multiple parameters; and
update the heat map to remove indications of influence of parts of the document corresponding to the de-selected parameter.

16. The non-transitory computer-readable medium of claim 9, wherein the instructions to generate for display the heat map comprise instructions to generate for display a plurality of heat maps, each respective one of the plurality of heat maps showing where the parts of the document influenced the prediction based on a respective parameter corresponding to the respective heat map.

17. A system for identifying relevant portions of documents, the system comprising:
memory with instructions encoded thereon; and
one or more processors that, when executing the instructions, are caused to perform operations of:
receiving, by a server, a request from a user to determine a prediction;
identifying, using the server, documents corresponding to the request;
identifying portions of the documents that inform the prediction;
inputting at least the portions of the documents into a machine learning model;
receiving, as output from the machine learning model, the prediction;
outputting the prediction for display to the user;
receiving a request from the user to view a document that informed the prediction; and
generating for display with the document a heat map that indicates how parts of the document that are included in the portions of the documents that informed the prediction influenced the prediction.

18. The system of claim 17, wherein receiving the request comprises receiving a selection of a topic, and wherein identifying the documents comprises identifying documents that correspond to the topic.

19. The system of claim 18, wherein the topic is a legal case, wherein receiving the request additionally comprises receiving a selection of an individual, and wherein the prediction is a likelihood of success of the individual in achieving a successful outcome in the legal case.

20. The system of claim 7, wherein identifying the portions of the documents that inform the prediction comprises:
inputting the documents into a machine learning model; and
receiving, as output from the machine learning model, an indication of the portions of the documents that inform the prediction.
